(19) United States
(12) Patent Application Publication
(10) Pub. No.: US 2006/0219437 A1
(43) Pub. Date: Oct. 5, 2006

(54) Tight-sealed cable connector

(76) Inventor: Teh-Tsung Chiu, Taipei Hsien (TW)

Correspondence Address: Teh-Tsung Chiu, 235 Chung-Ho, Box 8-24, Taipei, TW

(21) Appl. No.: 11/083,146

(22) Filed: Mar. 18, 2005

(51) Int. Cl. H02G 3/18

(52) U.S. Cl. 174/653

(57) ABSTRACT

A tight-sealed cable connector comprises a body; an inner liner installed within the body; the inner liner being a hollow body; the inner liner having a sealing end and an open end; the sealing end being waterproof, dust-proof and insect-proof; and a tightening unit engaged to the body. A firm ring is formed between the inner liner and a film layer for connecting the inner liner and the film layer; and the firm ring encloses a surface of a cable so as to have the effect of water-proof, dust-proof and insect-proof.

### FIELD OF THE INVENTION

The present invention relates to connectors, and in particular to a tight-sealed cable connector which can tightly engage with a cable so as to achieve the effect of waterproof, dust-proof and insect-protect to protect the device or the system using the connectors.

### BACKGROUND OF THE INVENTION

Referring to FIG. 1A, a conventional used connector is illustrated. The cable has a joint, a tightening unit, a clamping unit engaged between the joint and the tightening unit, and an inner liner in the clamping unit.

Since the two ends of the inner liner are opened, when the cable does not pass through the cable, the interior of the cable is communicated to the exterior. Thereby water, vapor, dusts, insects will enter into the cable and thus into the device or system using the connector.

With reference to FIG. 1B, another prior art connector is illustrated. An outlet of the tightening unit of a retainer has a dust-proof cover to provide a dust-proof effect, but it cannot prevent vapor from permeating into the cable. Thereby the cover easily falls out in transfer process. It is difficult to provide the effect of water proof, dust proof and insect proof.

### SUMMARY OF THE INVENTION

Accordingly, the primary object of the present invention is to provide a tight-sealed cable connector, wherein when the cable is not assembled to the joint, the inner liner does not break so as to have the effect of waterproof, dust-proof and insect-proof. When the joint is assembled to the cable, the inner liner will break and the break material will enclose the surface of the cable. By the clamping effect, the cable will be fixed tightly so that the system using the connector will have the effect of waterproof, dust-proof and insect-proof so that the system is protected.

A tight-sealed cable connector comprises a body; an inner liner installed within the body; the inner liner being a hollow body; the inner liner having a sealing end and an open end; the sealing end being waterproof, dust-proof and insect-proof; and a tightening unit engaged to the body. A firm ring is formed between the inner liner and a film layer for connecting the inner liner and the film layer; and the firm ring encloses a surface of a cable for water-proof, dust-proof and insect-proof.

The various objects and advantages of the present invention will be more readily understood from the following detailed description when read in conjunction with the appended drawing.

### BRIEF DESCRIPTION OF THE DRAWINGS

FIGS. 1A and 1B are exploded schematic view of the convention connector.

FIG. 2 is an exploded schematic view of the tight-sealed cable connector of the present invention.

FIG. 3 is an assembled view of the present invention.

FIGS. 4 and 5 are schematic views showing the operation of the present invention.

FIG. 6 is a schematic view of the second embodiment of the present invention.

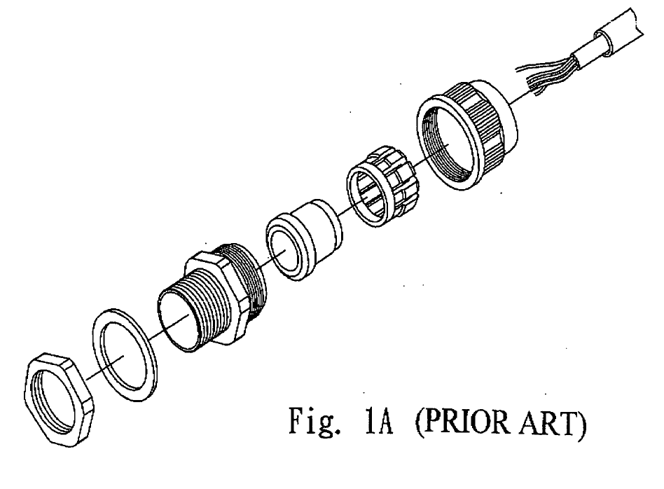

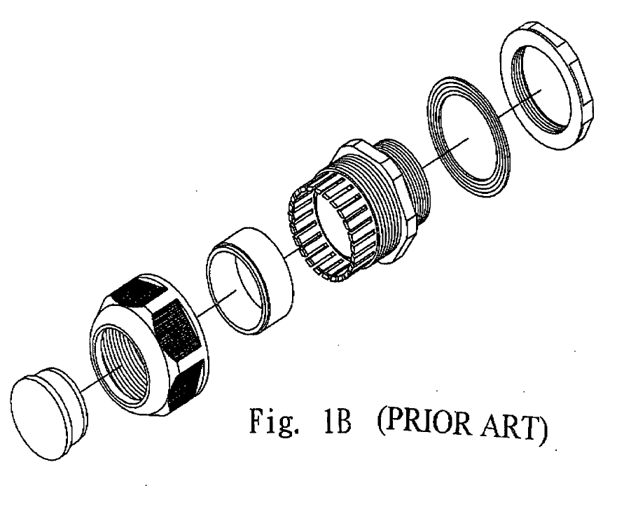

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

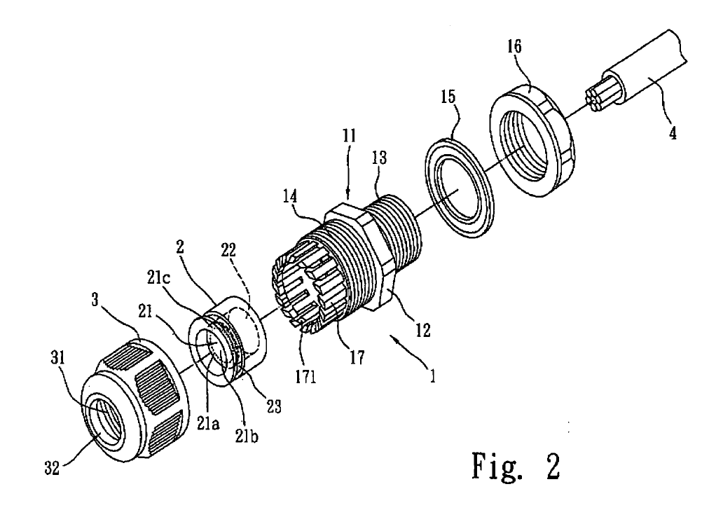

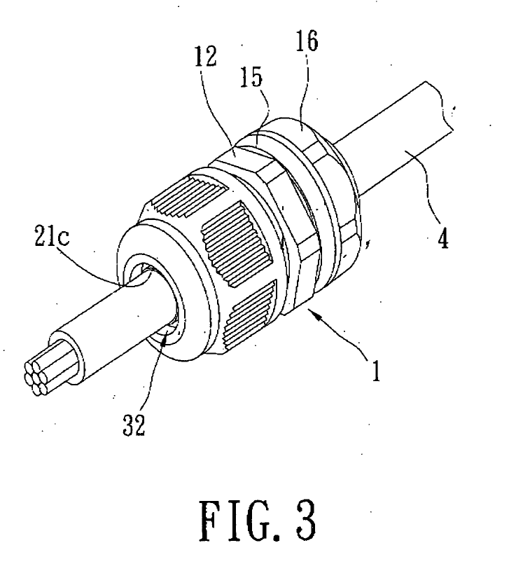

Referring to FIGS. 2 and 3, the tight-sealed cable connector of the present invention is illustrated, which is waterproof, dust-proof and insect-proof. As shown in the drawings, the connector 1 has the following elements.

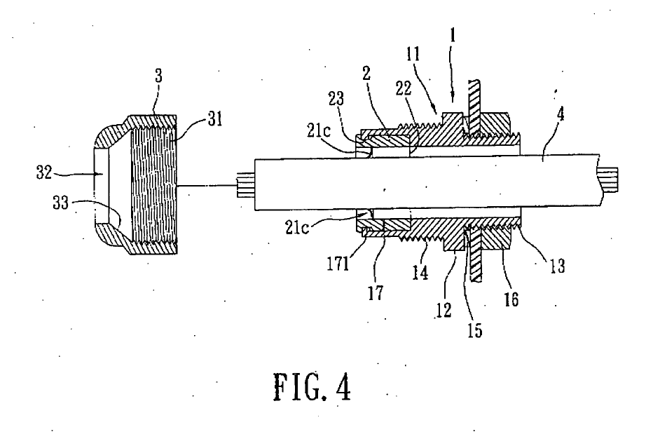

A hollow body 11 is included. The body 11 has a resisting portion 12, a front thread portion 13 and a rear threaded portion 14 at the front and rear sides of the resisting portion 12, respectively. A washer 15 and an annular locking means 16 are screwed into the front thread portion 13. Thereby the body 11 of the connector 1 can be assembled to a wall or a spacer. One end of the rear threaded portion 14 has a plurality of clamping sheets 17. Each clamping sheet 17 has a pressing portion 171 (referring to FIG. 4).

The inner liner 2 is a hollow body made of plastic material so as to be arranged into the plurality of clamping sheets 17. The inner liner 2 has a sealing end 21 and an open end 22. An outer surface of the inner liner 2 has a recess 23 between the sealing end 21 and the open end 22 for engaging with the pressing portions 171 of the clamping sheets 17. The sealing end 21 has a film layer 21b. The film layer 21b has an annular tearing line 21a which can be broken by a top end of a cable 4. When the cable 4 passes through the inner liner 2, the core wire of the cable 4 will resist against the film layer 21b of the sealing end 21. The film layer 21b will be torn along the tearing line 21a so as to be formed with a firm ring 21c.

The tightening unit 3 is a hollow body. An interior has a threaded combining portion 31 capable of engaging with the rear threaded portion 14 and an outlet 32. A tapered compressing surface 33 is formed between the threaded combining portion 31 and the outlet 32 (referring to FIG. 4) for tightening the clamping sheets 17 to be reduced inwards so that the tightening unit 3 is clamped in the inner liner 2.

By above mentioned components, a tight-sealed cable connector is formed, which is waterproof, dust-proof and insect-proof.

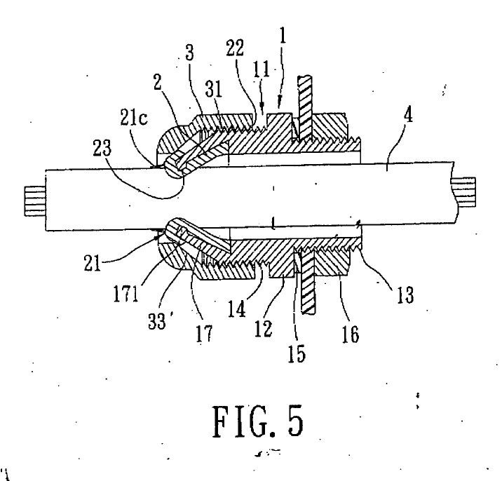

Referring to FIGS. 4 and 5, the cross sectional view of FIG. 3 is illustrated. As illustrated in the drawings, the body 11, inner liner 2 and tightening unit 3 serve to assemble the joint 1 of the present invention. When the cable 4 does not insert into the connector, the sealing end 21 of the inner liner 2 is sealed completely which is waterproof, dust-proof and insect-proof.

When the cable 4 inserts into the inner liner 2 and the body 11, the core wire of the cable 4 will resist against the film layer 21b of the sealing end 21. The film layer 21b will separate from the sealing end 21 along the tearing line 21a so as to form a firm ring 21c to form a hole to be passed by the cable 4. The inner diameter of the hole is smaller than an outer enclosure. Then, when the threaded combining portion 31 of the tightening unit 3 is locked to the rear threaded portion 14, the compressing surface 33 of the tightening unit 3 will compress the clamping sheets 17 so that the inner diameter of the clamping sheets 17 reduce inwards. As a result the pressing portions 171 of the clamping sheets 17 resist against the inner liner 2 so that the inner liner 2 tightly compress the cable 4 and thus the cable is tightly engaged.

After assembly, the firm ring 21c of the sealing end 21 of the inner liner 2 will enclose the surface of the cable 4 so as to have the effect of waterproof, dust-proof and insect-proof to protect the device.

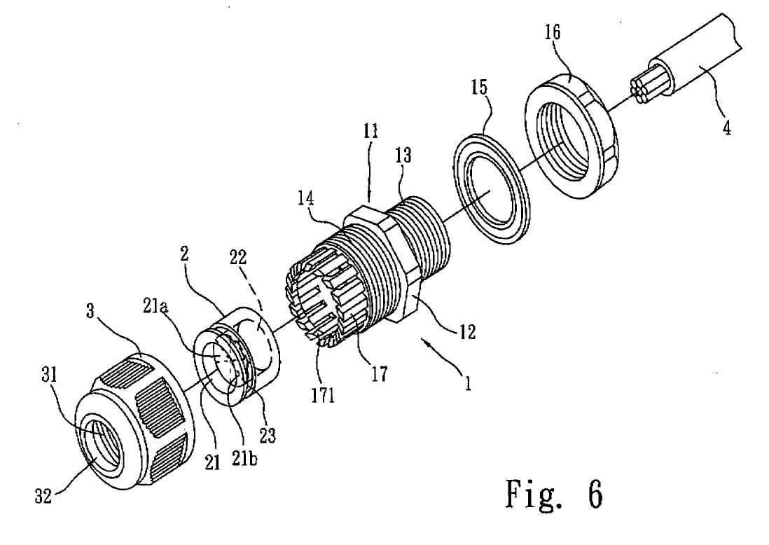

With reference to FIG. 6, a schematic view of another embodiment of the present invention is illustrated. In the sealing end 21 of the inner liner 2 of the present invention, other than being made of a film, a plurality of tearing wires 21a can be formed. When the cable 4 passes through the sealing end 21 of the inner liner 2, the inner liner 2 will break along the sealing end 21 so as to pass the cable 4. When the cable 4 passes therethrough, the torn sealing end 21 will enclose the surface of the cable. After the tightening unit 3 is assembled with the body 11, it will have the effect of waterproof, dust-proof and insect-proof so as to protect the system.

Moreover, in another embodiment of the present invention, the sealing end is formed with at least one tearing line. When a cable passing through the inner liner, the tearing line will be torn so as to enclose a surface of the cable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A tight-sealed cable connector comprising:
a body; the body having a resisting portion, a front thread portion and a rear threaded portion at a front side and a rear side of the resisting portion, respectively; a washer and an annular locking means being screwed into the front thread portion; thereby the body of the connector can be assembled to a wall or a spacer; one end or the rear threaded portion having a plurality of clamping sheets; each clamping sheet having a pressing portion;
an inner liner installed within the body; the inner liner being a hollow body; the inner liner having a sealing end and an open end; the sealing end being waterproof, dust-proof and insect-proof; an outer surface of the inner liner having a recess between the scaling end and the open end for engaging with the pressing portions of the clamping sheets; and the inner surface of the inner liner being smooth; and
a tightening unit engaged to the body; the tightening unit being a hollow body; an interior having a threaded combining portion capable of engaging with the rear threaded portion and an outlet; a tapered compressing surface being formed between the threaded combining portion and the outlet for tightening the clamping sheets so that the tightening unit is clamped in the inner liner;
wherein the inner liner is made of rubber;
wherein a sealing end of the inner liner is breakable;
wherein the sealing end of the inner liner is a film layer;
wherein the scaling end has a round tearing line;
wherein a firm ring is formed between the inner liner and a film layer for connecting the inner liner and the film layer; and the firm ring encloses a surface of a cable.

2-10. (canceled)
